(19) United States
(12) Patent Application Publication
(10) Pub. No.: US 2021/0279791 A1
(43) Pub. Date: Sep. 9, 2021

(54) SYSTEMS AND METHODS FOR RESIDENTIAL HABITABILITY SCORING AND DATA STORAGE

(71) Applicant: CribScore, Inc., Beverly Hills, CA (US)

(72) Inventor: Kathryn Cavanaugh JACOBY, Beverly Hills, CA (US)

(21) Appl. No.: 17/196,933

(22) Filed: Mar. 9, 2021

Related U.S. Application Data
(60) Provisional application No. 62/987,287, filed on Mar. 9, 2020.

(51) Int. Cl. G06Q 30/06; G06Q 50/16

(52) U.S. Cl. CPC G06Q 30/0645; G06Q 50/163

(57) ABSTRACT

A user system comprising: at least one hardware processor; and one or more software modules that are configured to, when executed by the at least one hardware processor, present a user interface to a user, wherein the user interface: prompts the user to start an inspection; receives an input to start the inspection; prompt the user to capture images of the outside of a rental unit; receive images of the outside of the rental unit; prompt the user to begin an indoor inspection workflow; receive images of a plurality of rooms and features of the rental unit; prompt the user to answer questions related to each of a plurality of variables and each of the plurality of rooms and features; and receive answers the various questions, wherein the answers include a numeric value.

### CROSS-REFERENCE TO RELATED APPLICATIONS

This application claims priority to U.S. Provisional Patent App. No. 62/987,287, filed on Mar. 9, 2020, which is hereby incorporated herein by reference as if set forth in full.

### BACKGROUND

### Field of the Invention

The embodiments described herein are generally directed to a habitability scoring platform and, more particularly, to a platform that provides an evidence-based communication hub for the condition of a particular property between landlord/owner, renter/tenant and service provider/vendor, including downloadable photos, leases, addendums, proof of payment, maintenance alerts system, etc.

### Description of the Related Art

Residential rental properties, i.e., single-family, multi-family, short-term rentals and college/universities rentals that comply with state established habitability guidelines and landlord/tenant laws are the best options for renters. Conventionally, however, a typical renter not only does not understand what eth habitability guidelines are, they don't know where to find them, and also do not understand what obligations the landlord has to then as a tenant under landlord tenant laws. Unlike the inspection period when buying a home, potential renters have limited access to critical habitability information as there is not any such inspection mechanism. Often, potential tenants who ask too many questions do not get the apartments. As such, renters are forced to rely on landlord/owner statements.

### SUMMARY

Accordingly, systems, methods, and non-transitory computer-readable media are disclosed to allow renters to get a score, termed a Cribscore that measures the habitability of the rental they are considering. Habitability information is provided by a number of different reliable sources including the landlord/owner, current/previous tenants, public records and those who are in the know about a particular rental space such as service providers, insurance companies, etc.

According to one aspect, a user system comprising: at least one hardware processor; and one or more software modules that are configured to, when executed by the at least one hardware processor, present a user interface to a user, wherein the user interface: prompts the user to start an inspection; receives an input to start the inspection; prompt the user to capture images of the outside of a rental unit; receive images of the outside of the rental unit; prompt the user to begin an indoor inspection workflow; receive images of a plurality of rooms and features of the rental unit; prompt the user to answer questions related to each of a plurality of variables and each of the plurality of rooms and features; and receive answers the various questions, wherein the answers include a numeric value.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 is a flow chart illustrating an example process for generating a Cribscore and generating a database included in the infrastructure of FIG. 1 according to one example embodiment;

FIG. 4 is an example report that depicts the information in the database of FIG. 1 according to one example;

FIGS. 5A and 5B illustrate example screens for a U/I included in a user system in the architecture of FIG. 1 according to one embodiment; and

FIG. 6 illustrates is a flow chart illustrating how a tenant can provide information through their system and application included in the architecture of FIG. 1.

### DETAILED DESCRIPTION

In an embodiment, systems, methods, and non-transitory computer-readable media are disclosed for analyzing and using property historical and condition (e.g. habitability) data is provided. The system and method may include obtaining property history and condition data from a property history and condition data system; and analyzing various property history and condition variables to determine final factors associated with such property and condition variables. The property and condition variables may be categorized based on the age of the property, events affecting condition of the property, the results of condition events of the property, the amount of time that has occurred since some condition event and/or occurrence of significance. The final factors can be combined to score particular properties on the basis of habitability and other factors; combined to express the health and well-being of the structure when contemplated for human inhabitants. Property history and condition scores can be used to evaluate the risk associated with a particular property, including use in underwriting and rating insurance policies, property financing, property warranties or state/municipal code compliance.

After reading this description, it will become apparent to one skilled in the art how to implement the systems and methods described in various alternative embodiments and alternative applications. However, although various embodiments will be described herein, it is understood that these embodiments are presented by way of example and illustration only, and not limitation. As such, this detailed description of various embodiments should not be construed to limit the scope or breadth of the present invention as set forth in the appended claims.

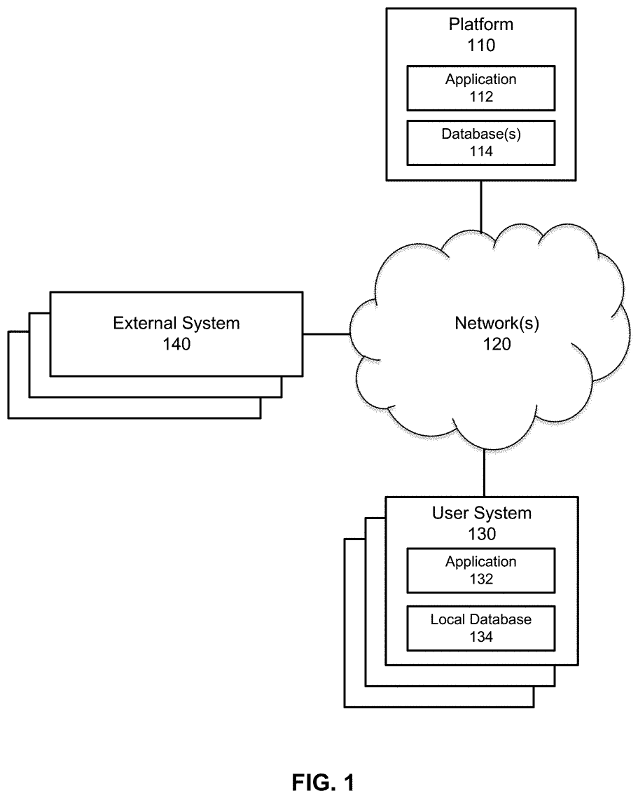

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

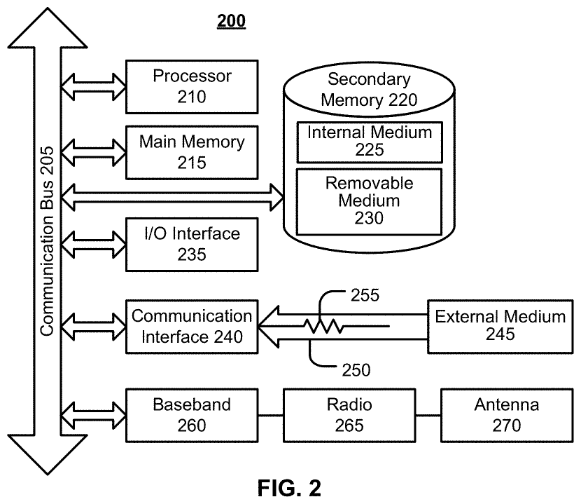

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for generating and communicating a habitability score will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application. In addition, the grouping of functions within a component, block, module, circuit, or step is for ease of description. Specific functions or steps can be moved from one component, block, module, circuit, or step to another.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In certain embodiments, platform 110 receives information from various sources, e.g., external systems 140 and user systems 130 and build a database 114 of habitability information and factors that can then be used to develop a habitability score for a particular rental unit. Platform 110 also provides an evidence-based communication hub for the condition of a particular property between landlord/owner, renter/tenant and service provider/vendor, including downloadable photos, leases, addendums, proof of payment, maintenance alerts system, etc. “Habitability” is used to describe a rental unit that is capable of being inhabited or lived-in. When a “home” is capable of being inhabited or lived-in based on a list of standards determined by the relevant state/municipality, a home is considered habitable and safe. That list of unit attributes or aspects that are measured go beyond the expected elements that make up a home. For example, aspects such as a door, a roof, windows with screens, running water, working electricity, toilets that work properly, etc. There are standards that are not so obvious to determine such as a home should be mold-free, have working doorbells, sealed crawl spaces and many other items that platform 110 can consider when determining the habitability or livability. In fact, in every lease in the United States (except Arkansas), there is a set of terms both landlords and tenants agree to called the Implied Warranty of Habitability. The habitability score is intended to convey whether a particular unit meets the requirements of Implied Warranty of Habitability and to what extent the unit exceeds them. Moreover, the score is broken down for a plurality of the type of aspects mentioned above, so the renter has granular knowledge about the unit's habitability.

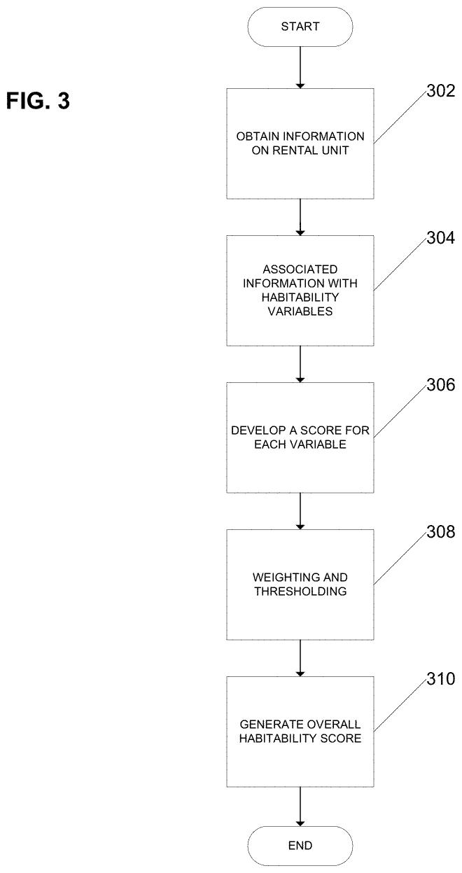

FIG. 3 is a flow chart illustrating an example process for generating a Cribscore and generating database 114 according to one example embodiment. First, in step 302, platform 110 can obtain via application 112 history and condition data for a plurality of rental units. This information can come from external systems 140 associated with third party sources, e.g., via API's, such as government sources, realtor systems, online real estate marketplaces such as Zillow, as well as from user systems 130. The process for obtaining information form a user device 120 is described in more detail below.

It should be noted that while the embodiments disclosed are directed to rental units, any real-estate transaction can use the systems and methods described herein, including residential or commercial real-state transactions. Any transaction where the habitability of the subject real-estate is an issue can use the systems and methods described herein.

The information obtained in step 302 can comprise listing information, inspection information, construction, damage, insurance claims, pictures, testimonials, etc. The information is then associated, in step 304, with various variables related to the unit. Examples of the variables are described in detail below.

In step 306, once the information is obtained, it can be evaluated in order to develop a score for each variable. The score can be a numerical selection from a range, i.e., 1-10, or 1-100. Alternatively, it can be expressed as a percentage. Moreover, the information can be manually evaluated and/or evaluated automatically using AI/ML.

The scores can then be weighted and thresholded, in step 308, in order to generate an overall habitability score in step 310. In other words, certain factors, like mold, may be more important with respect to habitability than others, e.g., working doorbell. Thus, variables such as mold can be weighted higher than others. This weighting can be built into the score. For example, mold may be rated on a scale of 1-100, whereas working doorbell is only rated on a scale of 1-10, such that the mold score will have bigger impact on the final score.

Thresholding can be different than weighting. For example, while a user can provide a score for mold, e.g., where a high score means little or no mold and a lower score indicates some mold, a threshold value or level can be used to indicate whether the amount of mold is acceptable, i.e., habitable. Thus, while the score on a scale of 1-10 for mold may be a 3, indicating a lot of mold, anything less than, e.g., an 8, may indicate an unacceptable amount. Like weighting, the thresholding can impact the overall score and/or just be communicated separately to the parties to let them know that regardless of the score, there is an unacceptable amount of mold present.

The weighting/thresholding can be accomplished via binary questions as described below. In other words, in addition to provide a score with respect to the presence of mold, the user can also provide a binary, e.g., “1’ or “0” with respect to the presence. Again, the binary value can be communicated separately, but it can also impact the score, e.g., by multiplying the score by the binary response.

The information obtained in step 302 as well as the scoring of steps 304 and 310 can all be stored in database 114 for communication to relative parties. The parties can then access the information via a user interface (U/I) provided on system 130 by application 132.

Obtaining property history and condition data from multiple sources including user-input and a property history database or system;

Thus, application 112 can utilize two or more sets of data to create a numerical CribScore that reflects (numerically) the suitability and habitability of a property and the integrity of the structure as determined by personal, historical and other data. Former and present tenants of a property may input their answers/documentation and/or evidenced claims pertaining to the habitability and suitability of a property. Also, present property owners, i.e. landlords, may input their answers/documentation and/or evidenced claims pertaining to the habitability, suitability and legal standing, i.e. state and local code compliance, of a residential property.

Platform 110 can use the acquired data to determine a preliminary “habitability” score, but can weight the information belonging to various categories according to category significance; for instance, strict “habitability” as it pertains to inhabitant welfare in relation to mold, critical systems, safety hazards and code compliance holds a greater “weight” when compared to aesthetic and/or auxiliary factors. Platform 110 can then generate a final habitability score.

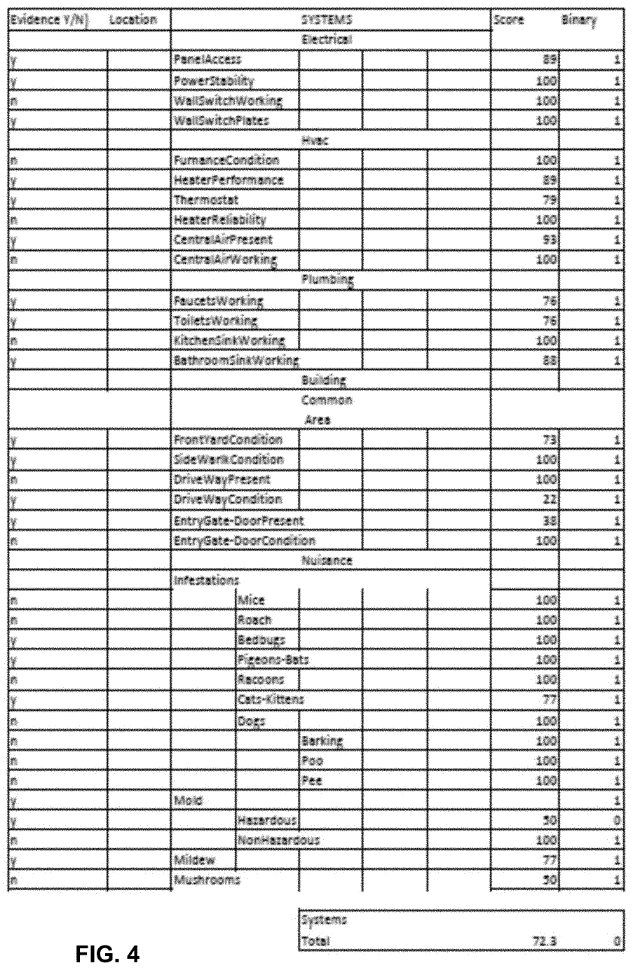

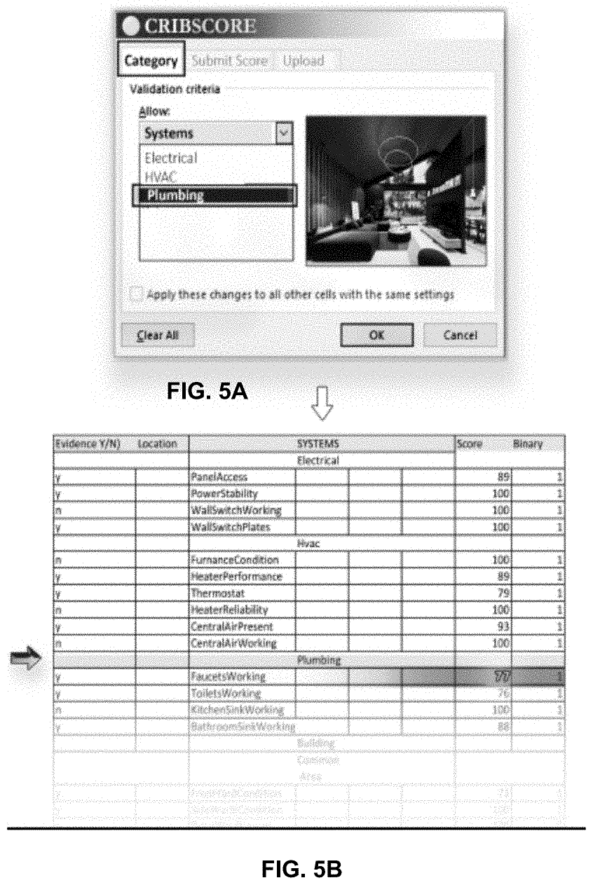

FIG. 4 is an example report that depicts the information in database 114 according to one example. The presentation of FIG. 5 can be a report that can be access by applications 132 and presented on a U/I included in system 130 or printed out. As can be seen, the variables can be separated by category, i.e., electrical or HVAC. The report can also indicate whether evidence, such as a picture is available. The score is also presented as well as binary responses.

FIG. 5A and FIG. 5B illustrate example screens for a U/I included in user system 130 according to one embodiment. Thus, a user, such as a tenant, former tenant, real estate agent, service provider, landlord, etc., can access the U/I on system 130, and select a category as in FIG. 5A. The user can then indicate and/or upload evidence such as pictures, etc. The user can then input the scores as illustrated in FIG. 5B. The information can then be uploaded to platform 110.

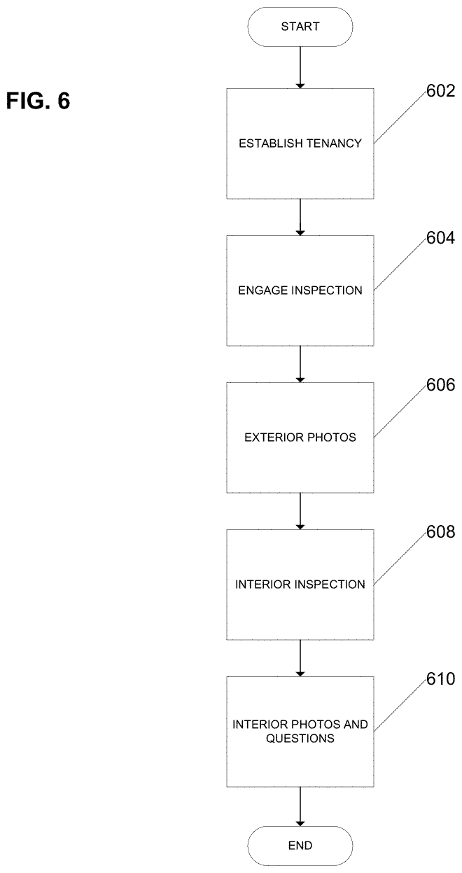

FIG. 6 is a flow chart illustrating how a tenant can provide information through their system 130 and application 132. First, in step 602 a user/tenant establishes tenancy at Sign-in (or ownership if a landlord or owner-occupant) and now the inspection begins using geo-locating processes that are time and date stamped. In step 604, the user uses application 132 and engages the inspection under User ID and, e.g., press START in the U/I. In step 606, the user follows the inspection steps starting with the Establishing Exterior Photos. In step 608, the user starts the interior inspection starting with, e.g., the front door. The inspection will follow the flow of the particular unit with each room to be inspected assigned a title/name via drop down menu set by the User.

An example of flow might include:
Front Door/Landing (exterior);
Foyer (interior);
Foyer Bath;
Living Room;
Dining Room;
Den/Great Room;
Kitchen;
Exterior Decking Connected to Common Areas;
Hallways Connected to Common Areas;
Bedroom #1;
Bathroom #1;
Bedroom #2;
Bathroom #2;
Laundry Room;
Hallways Connected to Bedrooms;
Exterior Decking Connected to Bedrooms;
Secondary Entry; and
Etc.

The user can take photos as directed by the Inspection Process in step 610. All photos will be stored/retained by platform 110. For each photo taken, habitability items such windows, doors, etc., can then be highlighted in, e.g., white for the user to select and start to answer, e.g., two questions for each item. For example, if the user has selected eth front door, then the following two binary questions can be asked:

Binary Question—Q1: Is there a front door?
Yes
No

A series of conditional question can then be asked, to which the user can respond with a score.

### Example

Binary Question—Q1: Is there a front door?
Answer—YES.
Conditional question could be as follows:

Door Handle is operational 100%=10;
Door Handle is loose=2;
Deadbolt is operational 50%=2;
Door Hinges are operational=3;
No Door Plate surrounds the lock and handle=0;
No Door seal strip/weather stripping=0;
Doorbell is not working=0;
Peephole is operational 100%=10; and
Threshold seal is operational 100%=10.
TOTAL CONDITIONAL POINTS=37

This sub-total score can be incorporated in the total CribScore. That total CribScore can be noted with areas of improvement—such as the items to fix on the front door for the Tenant, Landlord and Service Provider/Vendor to be educated on what is required to be a safe/habitable and to use in efforts to cure.

The tenant can gain knowledge about the condition of the front door is substandard indicating where/when/how/etc., if the condition complies with local habitability codes, how to fix and a direct email connection to the Landlord of the fixes needed.

The landlord gains knowledge of the condition of the front door, etc. Landlord will receive information on Crib Score Certified Service Providers/Vendors in the area to cure the condition (with references) and any deals available via HomeDepot (etc.) for materials, etc.

The service provider/vendor gains knowledge about work/repairs that need to be made and why.

It should be noted that platform 110 can manage the service/repair process. Once a report and score are finalized, the report can be communicated to both the tenant and the landlord. The application 132 in each user's system 130 can then be used to find registered and vetted service providers to come and address any issues raised in the report. Platform 110 can even be configured to act as the payment platform dispersing funds to the service provider, when the work is confirmed and approved, e.g., using application 132.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A user system comprising:
at least one hardware processor; and
one or more software modules that are configured to, when executed by the at least one hardware processor, present a user interface to a user, wherein the user interface:
prompts the user to start an inspection;
receives an input to start the inspection;
prompt the user to capture images of the outside of a rental unit;
receive images of the outside of the rental unit;
prompt the user to begin an indoor inspection workflow;
receive images of a plurality of rooms and features of the rental unit;
prompt the user to answer questions related to each of a plurality of variables and each of the plurality of rooms and features; and
receive answers the various questions, wherein the answers include a numeric value.

2. The user system of claim 1, wherein the one or more software modules are further configured, when executed by the at least one hardware processor to transmit the received images and answers to a platform.

3. The user system of claim 1, wherein the received answers further include binary answers.

4. The user system of claim 2, wherein the one or more software modules are further configured, when executed by the at least one hardware processor to receive a report from the platform detailing the answers and a score related to each of the plurality of answers as well as an overall habitability score for the rental unit and to display the report to the user via the user interface.

5. A platform comprising:
at least one hardware processor; and
one or more software modules that are configured to, when executed by the at least one hardware processor,
receive a plurality of images and answers related to each of a plurality of variables related to a rental unit and related to different rooms or aspects;
store the images and the answers in a database;
generate a habitability score for each of the plurality of variables;
generate an overall habitability score for the rental unit, based on the habitability score for each of the plurality of variables; and
generate a report detailing the answers and scores for each of the plurality of variables for each of the rooms and aspects as well as the overall habitability score.

6. The platform of claim 5, further configured to communicate the report to one or more user systems.

7. The platform of claim 5, further comprising thresholding and weighting the answers before generating the habitability score for each of the plurality of variables.
